(19) United States
(12) Patent Application Publication
(10) Pub. No.: US 2011/0055348 A1
(43) Pub. Date: Mar. 3, 2011

(54) LOCATION DETERMINATION SYSTEM AND METHOD

(76) Inventor: Peter William Black, Experance (AU)

(21) Appl. No.: 12/866,531

(22) PCT Filed: Feb. 6, 2009
(86) PCT No.: PCT/AU2009/000144

§ 371 Date: Nov. 11, 2010

(30) Foreign Application Priority Data
Feb. 8, 2008 (AU) 2008900601

(51) Int. Cl. G06F 15/16; G06F 17/30

(52) U.S. Cl. 709/217; 707/770; 379/207.12; 707/E17.014

(57) ABSTRACT

A location determination system and method in which a database stores details of locations of fixed landline or other communications devices alongside unique identifiers for these communications devices. These unique identifiers may be telephone numbers. The database can be queried to thereby determine the location of the communications device from the unique identifier. This will assist services such as the emergency services to determine locations of fixed communications devices such as landline telephones. The database can be in data communication with a server which can be accessed remotely if required.

### FIELD OF THE INVENTION

The present invention relates to a location determination system and method and in particular, a system and method for identifying or determining the location of a communications device, such as, for example, a telephone.

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

### BACKGROUND ART

The following discussion of the background to the invention is intended to facilitate an understanding of the present invention. However, it should be appreciated that the discussion is not an acknowledgment or admission that any of the material referred to was published, known or part of the common general knowledge of the person skilled in the art in any jurisdiction as at the priority date of the invention.

Requests for emergency assistance—such as ambulance, fire or other emergency services—are often made by a fixed landline telephone in which an emergency number (such as, for example, 000 in Australia, and 911 in the United States of America) is dialed and the caller is immediately connected to an operator who can call on the required services. While the operator may have details of the telephone number, for example through caller ID, the operator does not always have information as to the actual location of the telephone (and therefore the caller).

This requires the operator to ask for the (geographical or physical) address or location of the caller. This information may not always be forthcoming due to the stressful nature of the call (and may, in some circumstances, not even be known to the caller: who may not be the actual person living at the address at which the telephone is located).

Even when the address is correctly provided, or available, this does not necessarily mean that the caller can be easily located. This is because, for example, some streets may be long, truncated by train lines or rivers necessitating detours by emergency vehicles, not shown on maps, or incorrectly shown on maps. In any of these, or similar, events there is a significant risk that the emergency services will not reach the caller in the shortest possible or sufficient time—leading to further injury or death.

While locations of handheld cellular radio telephones may be determined by the use of triangulation techniques using received signal strength data from three local base stations, this is not possible for some other communications devices, including fixed landline telephones.

Fixed landline telephone numbers are often related to some extent to geographical area, for example, post codes. However, these areas can be expansive and so do not give any indication as to exact location. Telephone numbers will usually be linked to a street address, but this may not always be available to an operator, and, even if it is, it may not assist in directing the emergency services to the exact location of a caller, for the reasons given above.

The expeditious determination of the geographic or physical location of a caller is desirable in non-emergency situations as well. For example, delivery services and transport services rely on determining the location of a caller requesting their respective services. Delay in locating the caller in such instances may be costly to the service provider, and the caller.

### DISCLOSURE OF THE INVENTION

According to a first aspect of the present invention, there is provided a location determination system comprising a server coupled to a database, the database being arranged to store details of at least one communications device along with corresponding location data, wherein the server is operable to query the database to retrieve location data for the communications device details.

Preferably, the details of the at least one communications device comprises a unique communications device identifier.

Preferably, the unique communications device identifier comprises a unique number.

Preferably, the unique number is a telephone number.

Preferably, the communications device is a fixed line communications device.

Preferably, the communications device comprises a telephone.

Preferably, the telephone comprises fixed landline telecommunications apparatus.

Preferably, the communications device comprises a networked computer.

Preferably, the server is arranged to be in data communication with one or more terminals.

Preferably, users of the terminals can access the server to query the database.

Preferably, the terminals are remote from the server.

Preferably, the location data comprises the physical geographical coordinates of the communications device.

More preferably, the physical geographical coordinates are the Global Positioning System (“GPS”) coordinates of the location of the communications device.

Preferably, the communications device details stored by the database further include additional data.

Preferably, the additional data includes one or more of: the distance of the communications device from the nearest road; the nearest hospital; the nearest neighbour; and cellular radio telephone range or distance.

Preferably, the server and the database are coupled to the terminals by a wide area network such as the Internet.

Preferably, the server and the database are coupled to the terminals by a fixed, direct connection.

According to another aspect of the present invention, there is provided a method for determining the location of a communications device, the method comprising querying a database coupled to a server, the database being arranged to store details of the communications device along with corresponding location data, whereby the querying of the database retrieves location data for the communication device details.

Preferably, the method further comprises using a terminal in data communication with the server to query the database.

Preferably, the details of the communications device comprise a unique communications device identifier.

Preferably, the method further comprises: receiving a request from the communications device for attendance at the location, interrogating the database for the unique communications device identifier and corresponding location data, and determining the location of the communications device from the location data in the database.

Preferably, the method further comprises providing an attending service with the location data.

Preferably, the unique communications device identifier comprises a unique number.

Preferably, the unique number is a telephone number.

Preferably, the communications device is a fixed line communications device.

Preferably, the communications device comprises a telephone.

Preferably, the communications device comprises a networked computer.

Preferably, the server is arranged to be in data communication with one or more terminals and users of the terminals can access the server to query the database.

Preferably, the location data comprises the physical geographical coordinates of the communications device.

Preferably, the physical geographical coordinates are the Global Positioning System (“GPS”) coordinates of the location of the communications device.

Preferably, the communications device details stored by the database further include additional data.

Preferably, the additional data includes one or more of: the distance of the communications device from the nearest road; the nearest hospital; the nearest neighbour; and cellular radio telephone range or distance.

### BRIEF DESCRIPTION OF THE DRAWINGS

The present invention will now be described, by way of example only, with reference to the accompanying drawing, of which:

FIG. 1 is a schematic block representation of an embodiment of a location system in accordance with an aspect of the present invention.

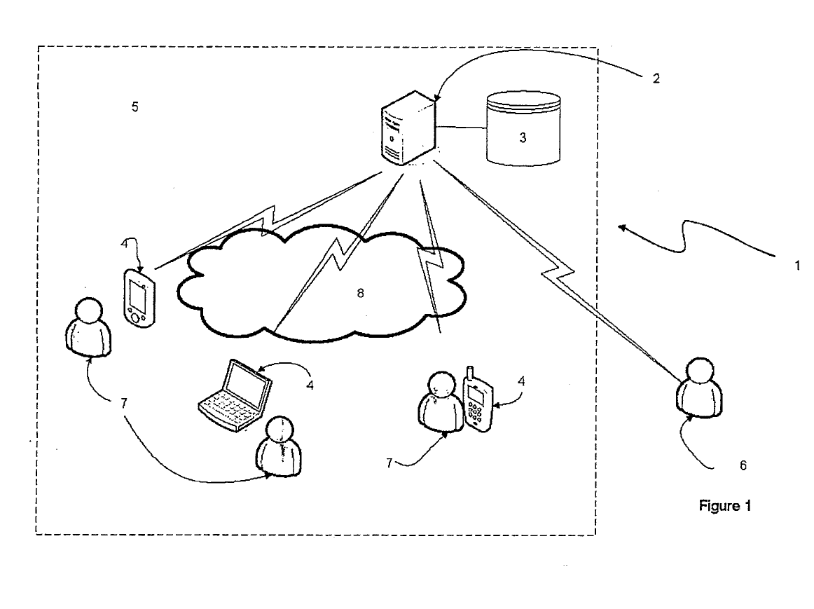

### BEST MODE(S) FOR CARRYING OUT THE INVENTION

Throughout the specification, in the present invention, the term ‘telephone’ within the context of the device for which information is stored, refers to any fixed landline telecommunications apparatus, such as those connected to a PTT exchange by copper wire, fibre optic or any other suitable connection means as is known to persons skilled in the art.

The embodiment of the invention comprises a location determination or identification system 1 for determining or identifying the location of a communications device.

In the embodiment described, the communications device is a telephone. In alternative embodiments of the invention, the communications device may be another localised device capable of sending (and preferably receiving) data or information, such as a networked personal computer, or emergency transmitter.

The location identification system 1 comprises processing means in the form of a server 2 coupled to a database 3. The server 2 is arranged to be coupled to one or more terminals 4. In the embodiment described, the terminals 4 are remote from the server 2. In an alternative embodiment of the invention, the terminals are proximate the server 2.

The terminals 4 comprise any suitable communications device such as a personal computer, or a telecommunications device, such as a fixed landline or cellular radio telephone. The terminals 4 can be coupled to the server 2 via the Internet 8, via a direct connection, or via a network (local or wide area) as may be required, and as appropriate for the type of terminal 4 and the means of communication with the server 2.

For example, a computer may be coupled to the server 2 via the Internet 8 as is well known to persons skilled in the art using a web browser as an interface and communicating with the server 2 using an appropriate communications protocol that is preferably secure. In any event the communication with the server 2 is according to any appropriate and suitable communications protocol as is well known to persons skilled in the art that enables a remote user 7, using a terminal 4 to access the server 2 and to access data stored on the database 3 as will be described in further detail below. The ability for remote terminals to access computer servers and databases is well known to persons skilled in the art, and, as such, need not be described in any further detail herein, except as is relevant to the present invention.

The database 3 is of any suitable known type such as a relational database queried by means of a suitable query language. As databases are well known to persons skilled in the art, this will not be described in any further detail herein except as is relevant to the present invention.

In the present embodiment, the terminals 4 are provided within an emergency call centre 5, such as that called when calling 000 in Australia, or 911 in the United States of America.

The database 2 stores details of all available fixed landline telephone numbers along with data that details the exact location of the telephone. In this embodiment, the data comprises physical latitude and longitude data as determined via the Global Positioning System (“GPS”).

In the embodiment described, for example, for the telephone having telephone number 1234 5678 the corresponding location data for the telephone stored in the database is:

| | | | |
|---|---|---|---|
| 30 degrees | 30 minutes | 15.28 seconds | South |
| 141 degrees | 50 minutes | 28.21 seconds | East |

The GPS data is collected by use of a GPS Locator device in the described embodiment and entered into the database 2. In alternative embodiments of the invention, the GPS data may be collected by other means, such as via maps or software.

Other relevant or prescribed data or information can also be stored, such as distance of the telephone from the nearest road, the nearest hospital, the nearest neighbour, cellular radio telephone range or distance and so on.

The server 2 runs a software application that enables users of the location determination system 1 and coupled to the location identification system 1 via the terminals 4 to access the database 3.

In the embodiment, for example, a caller (not shown) operates the telephone having telephone number 1234 5678 to call a user 7 of the location determination system 1, the user 7 being an operator of the emergency call centre 5, to request emergency assistance.

The user 7, accessing the server 2 via a wide area network such as the Internet 8, is presented with a log-in screen on their web browser as is well known to persons skilled in the art. The user 7 is required to enter their username and password in appropriate fields which is compared to data stored in the database 3. If this data matches that stored in the database 3, then the user is allowed access to the database 3. The user 7 is then presented with a screen via their web browser into which they can enter the number of the telephone whose location is required. The server 2 is then operable to interrogate or query the database 3 and determine the GPS coordinates stored in the database 3 against the required telephone number, 1234 5678 in the example described. The corresponding GPS coordinates are then displayed to the user 7 via the web browser.

The user 7 is then able to forward this information to the required emergency services personnel or others 6 who can then use this data to more quickly find the caller—for example, by entering the database coordinates into a satellite navigation system in their emergency vehicle.

By having the actual, physical geographical coordinates of the location of the telephone operated by the caller, and not just, for example, the street address, the emergency services personnel are able to adopt the most expeditious route to the callers exact location and rescue vehicle (e.g. ambulance, helicopter, etc) to use.

In this regard, over time, street names may be changed, new streets may be added, and existing streets may be moved or altered, and so relying on the street address is unreliable. The actual, physical geographical coordinates of the location of the telephone operated by the caller (the physical latitude and longitude location data, or GPS location data, of the fixed communications device) will not change over time, and so can be relied upon by the emergency services personnel.

In an alternative embodiment of the invention, where the terminal 4 is a telephone, the username and password can be input by the telephone using the keypad, the DTMF tones being used to determine the input data—in a manner well known to persons skilled in the art.

The server 2 is operable to parse the received information and query the database 3 and grant permission for the user 7 to use the location identification system 1 as described above. The user 7 may be provided by vocal prompts, or via the telephone's display, to enter the telephone number again using the telephone's keypad.

When the server 2 receives the telephone number details via the telephone, it queries the database 3 as described above and forwards the details to the user 7 via the telephone using the telephones display or using vocal prompts as is well known to persons skilled in the art.

In another embodiment of the invention, the server 2, on receipt of the call from the caller to the emergency call centre 5 on the emergency number 000, for example, is operable via the software to automatically interrogate or query the database 3 and determine the GPS coordinates stored in the database 3 against the required telephone number, and automatically display the location data to the user 7 along with the telephone number and other relevant recorded information. This is advantageous as the location data, telephone number and other information may be made available and displayed to the user 7 without any action required on their part, resulting in increases in efficiency and response speed. The server 2 may be further operable to automatically provide the location data to attending service personnel, to expedite their reaction thereto.

It will be apparent to persons skilled in the art that modifications and variations are possible within the scope of the present invention, and that the invention is not limited to the embodiments described. For example, the invention as described can include the following modifications and/or additions:
Any suitable communications devices and protocols can be used. Rather than being a telephone, the communications device may be a personal computer networked so as to be operable to send communications (such as emails) to the user 7, or the server 2. In such a case, a unique identifier for the personal computer would be stored in the database 3, along with the corresponding data pertaining to the physical, geographic location of the personal computer. The communication would comprise a message including a request for assistance and the unique identifier. Upon receipt of the communication, the database 3 would be interrogated to determine the location of the personal computer from the corresponding location data in the database 3.
The invention is applicable in any situation in which the location of a communications device needs to be determined, and is not limited to emergency situations. For example, the invention may be used for freight delivery, courier, or other transport services such as taxi services. In such a case, a communication received from a communications device may comprise a request for the desired service. Once the location of the communications device has been determined, the appropriate service personnel are dispatched to the location to provide the requested service.

1. A location determination system comprising a server coupled to a database, the database being arranged to store details of at least one communications device along with corresponding location data, wherein the server is operable to query the database to retrieve location data for the communications device details.

2. A location determination system according to claim 1, wherein the details of the at least one communications device comprises a unique communications device identifier.

3. A location determination system according to claim 2, wherein the unique communications device identifier comprises a unique number.

4. A location determination system according to claim 3, wherein the unique number is a telephone number.

5. A location determination system according to claim 1, wherein the communications device is a fixed line communications device.

6. A location determination system according to claim 5, wherein the communications device comprises a telephone.

7. A location determination system according to claim 6, wherein the telephone comprises fixed landline telecommunications apparatus.

8. A location determination system according to claim 1, wherein the communications device comprises a networked computer.

9. A location determination system according to claim 1, wherein the server is arranged to be in data communication with one or more terminals.

10. A location determination system according to claim 9, wherein users of the terminals can access the server to query the database.

11. A location determination system according to claim 9, wherein the terminals are remote from the server.

12. A location determination system according to claim 1, wherein the location data comprises the physical geographical coordinates of the communications device.

13. A location determination system according to claim 12, wherein the physical geographical coordinates are the Global Positioning System (“GPS”) coordinates of the location of the communications device.

14. A location determination system according to claim 1, wherein the communications device details stored by the database further include additional data.

15. A location determination system according to claim 14, wherein the additional data includes one or more of: the distance of the communications device from the nearest road; the nearest hospital; the nearest neighbour; and cellular radio telephone range or distance.

16. A location determination system according to claim 9, wherein the server and the database are coupled to the terminals by a wide area network such as the Internet.

17. A location determination system according to claim 9, wherein the server and the database are coupled to the terminals by a fixed, direct connection.

18. A method for determining the location of a communications device, the method comprising querying a database coupled to a server, the database being arranged to store details of the communications device along with corresponding location data, whereby the querying of the database retrieves location data for the communication device details.

19. A method according to claim 18, wherein the method further comprises using a terminal in data communication with the server to query the database.

20. A method according to claim 18, wherein the details of the communications device comprises a unique communications device identifier.

21. A method according to claim 20, wherein the method further comprises: receiving a request from the communications device for attendance at the location, interrogating the database for the unique communications device identifier and corresponding location data, and determining the location of the communications device from the location data in the database.

22. A method according to claim 18, wherein the method further comprises providing an attending service with the location data.

23. A method according to claim 18, wherein the unique communications device identifier comprises a unique number.

24. A method according to claim 23, wherein the unique number is a telephone number.

25. A method according to claim 18, wherein the communications device is a fixed line communications device.

26. A method according to claim 18, wherein the communications device comprises a telephone.

27. A method according to claim 18, wherein the communications device comprises a networked computer.

28. A method according to claim 18, wherein the server is arranged to be in data communication with one or more terminals and users of the terminals can access the server to query the database.

29. A method according to claim 18, wherein the location data comprises the physical geographical coordinates of the communications device.

30. A method according to claim 29, wherein the physical geographical coordinates are the Global Positioning System (“GPS”) coordinates of the location of the communications device.

31. A method according to claim 18, wherein the communications device details stored by the database further include additional data.

32. A method according to claim 31, wherein the additional data includes one or more of: the distance of the communications device from the nearest road; the nearest hospital; the nearest neighbour; and cellular radio telephone range or distance.

33.-34. (canceled)
